(19) United States
(12) Patent Application Publication
(10) Pub. No.: US 2013/0018770 A1
(43) Pub. Date: Jan. 17, 2013

(54) VARIABLE EXPOSURE CONTRACT

(71) Applicants: Richard Co, Chicago, IL (US); Steve Youngren, Elgin, IL (US); John Wiley, New York, NY (US); David Boberski, Westport, CT (US); John Labuszewski, Westmont, IL (US); John Nyhoff, Darien, IL (US)

(72) Inventors: Richard Co, Chicago, IL (US); Steve Youngren, Elgin, IL (US); John Wiley, New York, NY (US); David Boberski, Westport, CT (US); John Labuszewski, Westmont, IL (US); John Nyhoff, Darien, IL (US)

(21) Appl. No.: 13/183,132

(22) Filed: Jul. 14, 2011

(51) Int. Cl. G06Q 40/00

(52) U.S. Cl. 705/37

(57) ABSTRACT

The disclosed embodiments relate to a futures contract, the value of which is based on the value of the underlying asset multiplied by a variable multiplier value which is based on a variable parameter.

### BACKGROUND

Futures Exchanges, referred to herein also as an “Exchange”, such as the Chicago Mercantile Exchange Inc. (CME), provide a marketplace where futures and options on futures are traded. Futures is a term used to designate all contracts covering the purchase and sale of financial instruments or physical commodities for future delivery or cash settlement on a commodity futures exchange. A futures contract is a legally binding agreement to buy or sell a commodity at a specified price at a predetermined future time. An option is the right, but not the obligation, to sell or buy the underlying instrument (in this case, a futures contract) at a specified price within a specified time. Each futures contract is standardized and specifies commodity, quality, quantity, delivery date and settlement. Cash Settlement is a method of settling a futures contract by cash rather than by physical delivery of the underlying asset whereby the parties settle by paying/receiving the loss/gain related to the contract in cash when the contract expires.

Typically, the Exchange provides a “clearing house” which is a division of the Exchange through which all trades made must be confirmed, matched and settled each day until offset or delivered. The clearing house is an adjunct to the Exchange responsible for settling trading accounts, clearing trades, collecting and maintaining performance bond funds, regulating delivery and reporting trading data. The essential role of the clearing house is to mitigate credit risk. Clearing is the procedure through which the Clearing House becomes buyer to each seller of a futures contract, and seller to each buyer, also referred to as a “novation,” and assumes responsibility for protecting buyers and sellers from financial loss by assuring performance on each contract. This is effected through the clearing process, whereby transactions are matched. A clearing member is a firm qualified to clear trades through the Clearing House.

As an intermediary, the Exchange bears a certain amount of risk in each transaction that takes place. To that end, risk management mechanisms protect the Exchange via the Clearing House. The Clearing House establishes clearing level performance bonds (margins) for all Exchange products and establishes minimum performance bond requirements for customers of Exchange products. A performance bond, also referred to as a margin, is the funds that must be deposited by a customer with his or her broker, by a broker with a clearing member or by a clearing member with the Clearing House, for the purpose of insuring the broker or Clearing House against loss on open futures or options contracts. This is not a part payment on a purchase. The performance bond helps to ensure the financial integrity of brokers, clearing members and the Exchange as a whole. The Performance Bond to Clearing House refers to the minimum dollar deposit which is required by the Clearing House from clearing members in accordance with their positions. Maintenance, or maintenance margin, refers to a minimum amount, usually smaller than the initial performance bond, which must remain on deposit in the customer's account for any position at all times. The initial margin is the total amount of margin per contract required by the broker when a futures position is opened. A drop in funds below the maintenance margin level requires a deposit back to the initial margin level, i.e. a performance bond call. If a customer's equity in any futures position drops to or under the maintenance level because of adverse price action, the broker must issue a performance bond/margin call to restore the customer's equity. A performance bond call, also referred to as a margin call, is a demand for additional funds to bring the customer's account back up to the initial performance bond level whenever adverse price movements cause the account to go below the maintenance margin level.

Equity investors were perhaps spoiled by the major, long-term bull market experienced between 1982 and 2000. Market events over the past decade, highlighted by the major market sell-off in the wake of the so-called subprime mortgage crisis, underscore the fact that equity markets cannot be expected continuously to advance over time.

Over course, it is equally easy to take advantage of anticipated equity market declines as it is for anticipated market advances, simply by shorting CME stock index futures. Likewise, equity asset managers may sell CME stock index futures as part of a hedging program. However, some investors may artificially be constrained in their ability to hold short market positions by their charters, internal policies or regulatory considerations.

### BRIEF DESCRIPTION OF THE DRAWINGS

FIG. 1 shows a block diagram of an exemplary network for trading futures contracts, including in which payer contracts may be implemented, according to one embodiment.

FIG. 2 a block diagram of an exemplary implementation of the system of FIG. 1 for administering variable exposure contracts.

FIG. 3 depicts a flow chart showing operation of the system of FIGS. 1 and 2.

FIG. 4 shows an illustrative embodiment of a general computer system 400 for use with the system of FIG. 1.

FIG. 5 shows a graph depicting the value of S&P 500 over an exemplary time period.

FIG. 6 shows parameters of an S&P Inverse Futures contract.

FIGS. 7-9 show parameters of exemplary contracts according to the disclosed embodiments.

### DETAILED DESCRIPTION OF THE DRAWINGS AND PRESENTLY PREFERRED EMBODIMENTS

To take advantage of market declines, considerable interest and activity has developed for “short” Exchange Traded Funds (ETFs) based on a variety of popular stock indexes. These ETFs allow one to buy a position that will benefit from market declines—a “short” ETF if you will.

The disclosed embodiments relate to a futures contract, the value of which is based on the value of the underlying asset multiplied by a variable multiplier value which is based on a variable parameter. The disclosed futures contract may be referred to as a “Variable Exposure Futures” contract or “VE” contract. These contracts are envisioned as a means to enhance trader and investor capabilities to—(1) take advantage of, or to hedge the risks attendant to a bear market, i.e. a market where prices are falling; (2) to create an automated variable risk exposure keyed to various economic or financial indicators, which capability could be used to created a “synthetic” portfolio insurance program. In particular, a system is disclosed for automated creation and administration of futures contracts, where the contracts are priced, i.e. settled, by reference to the value of an underlying asset, such as an index, and a variable multiplier value, which may be positive or negative, or range between positive and negative values. The variable multiplier may be “keyed” to a specific market indicator, which allows the contracts to provide a variable amount of risk exposure. Where the multiplier is always a negative value, the contract may be referred to as an “Inverse Variable Exposure Futures” contract.

The disclosed embodiments have application prospectively in product areas, such as those of CME Group, including stock indexes, interest rates, currencies and commodities. Variable exposure contracts have many potential applications such as to provide a “synthetic” form of portfolio insurance absent many of the attendant difficulties, described in more detail below.

Equity asset managers frequently wish to hedge their stock market holdings against the risk of bear markets. This is accomplished by the sale of conventional stock index futures. The disclosed embodiments relate to a system for administering inverse variable exposure futures contracts where one may buy a contract that will benefit from market declines. These could be appealing to market participants where investment constraints, such as by charter, policy or regulation, hinder the ability to sell or go short conventional stock index futures.

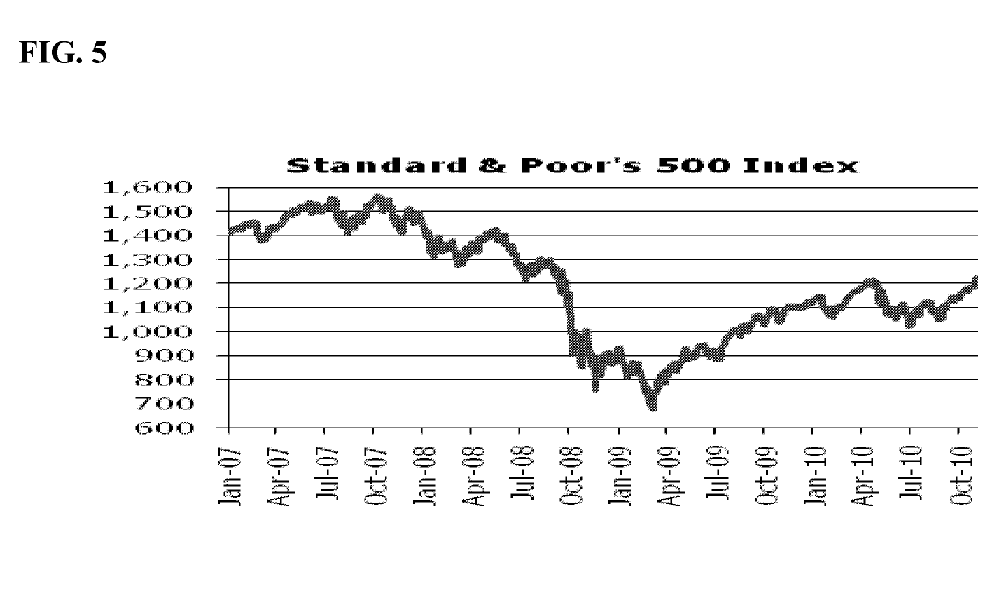

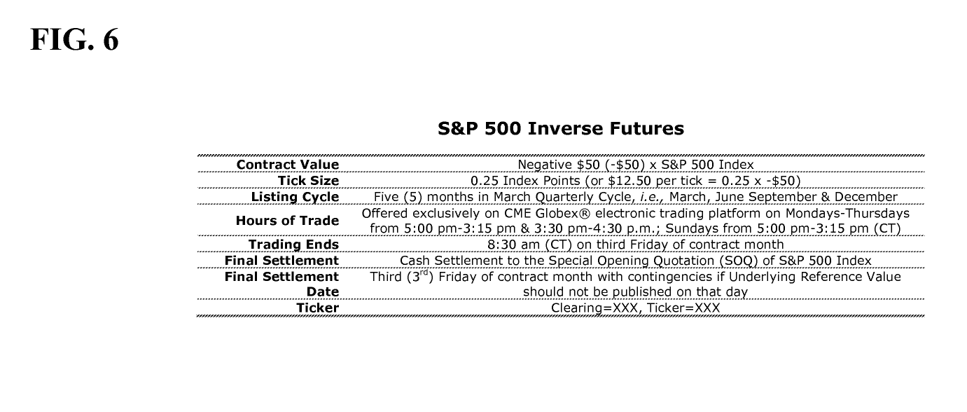

For example, E-mini Inverse S&P 500 futures would allow an investor to buy a contract that will benefit from market declines (See FIG. 5); in other words, to buy a short position. Likewise, one may benefit from market advances by selling an E-mini Inverse S&P 500 futures—to sell what essentially performs like a long position. E-mini Inverse S&P 500 futures may be patterned after CME's highly successful E-mini S&P 500 futures except that, rather than using a contract Multiplier of $50× the index, an Inverse futures contract employs a Multiplier of negative $50 (−$50) times the index. The contract, as shown in FIG. 6, is otherwise quoted in exactly the same way that standard E-mini S&P 500 futures are quoted, i.e., in (positive) index points with a minimum tick size of 0.25 index points (or $12.50 per tick). In all other ways, Inverse futures may be administered just like standard E-mini S&P 500 futures.

In contrast with positive or negative static multipliers, Variable Exposure (VE) futures contracts are designed to provide a variable amount of risk exposure, by reference to a particular formula, and as applied or “keyed” to a specific market indicator, thereby providing an additional dimension of exposure control. The mechanism by which this is accomplished is a variable contract Multiplier, which may be positive or negative, or range therebetween including zero, depending upon the implementation. For example, the conventional E-mini S&P 500 futures contract is valued at $50× Index levels, the $50 multiplier being fixed. The multiplier is fixed at a constant $50 regardless of any other considerations. In contrast, VE futures are constructed such that the contract Multiplier is variable, such as in response to different market conditions.

In one embodiment, a “key” on which a VE contract may be created is the value of the underlying instrument associated with the contract. For example, if the contract is based on the S&P 500, the contract “key” may be a direct reference to the current value of the S&P 500. Other keys may be the value of the Nasdaq-100 or even to indexes or benchmarks associated with other asset classes. The underlying instrument may also be keyed to macro-economic factors such as real or nominal U.S. GDP or the U.S. unemployment rate.

As such, and contingent upon the level of the S&P 500, the contract Multiplier may be adjusted upwards or downwards. This adjustment may be accomplished mechanically through Exchange and bookkeeping service vendors automated accounting systems.

As an alternative to direct reference to the value of the underlying instrument, the contract Multiplier may be keyed to peripheral or adjacent values. Consider that the Multiplier for an S&P 500 contract may be keyed to the value of the Nasdaq-100 or even to indexes or benchmarks associated with other asset classes. E.g., contracts may be constructed that key the contract Multiplier to prevailing short-term or long-term interest rates, exchange rates or commodity values, etc. Benchmark rates such as the BBA LIBOR rate, Fed Funds rate, Treasury yields, USD/Euro rate, USD/Japanese yen rate, or West Texas Intermediate crude oil might be referenced for these purposes.

Further, an index may be keyed to macro-economic factors. Key economic indicators such as Gross Domestic Product (GDP), an unemployment rate, Consumer or Producer Price Indexes (CPI or PPI) represent possibilities in this regard.

The rationale for reference to such alternate keys may be quite varied. Certainly foreign investors in U.S. equities are impacted by exchange rates that describe the relationship of the U.S. dollar to their own local currency, in addition to the value of the U.S. equities. Or multi-asset class investors who allocate their resources amongst stocks and bonds might find use for a contract whose risk exposure to stocks or bonds is inversely related to the performance of bonds or stocks, respectively.

In addition to keying off of various economic or financial indicators, VE contracts may be created using various formulas to dictate the value of the contract Multiplier. These include reference to market ranges, linear functions or exponential functions. The most obvious way to calculate the Multiplier is by reference to market price ranges. The Multiplier might be adjusted either up or down in direct proportion or in inverse proportion to the range in which the S&P 500 Index is recorded, as shown in Table 1 below. The Multiplier may further be established as either a positive or a negative number (an inverse variable exposure contract) for various purposes.

TABLE 1
Range-Based Multiplier Example

| S&P 500 Range | Multiplier |
|---|---|
| 400.00 or below | ($70) |
| 600.00-799.99 | ($65) |
| 800.00-999.99 | ($60) |
| 1,000.00-1,199.99 | ($55) |
| 1,200.00-1,399.99 | ($50) |
| 1,400.00-1,599.99 | ($45) |
| 1,600.00-1,799.99 | ($40) |
| 1,800.00-1,999.99 | ($35) |
| 2,000.00 or above | ($30) |

Other examples of multiplier formulas include (where C=a constant):
Linear function (Multiplier=C×keyed value)
Inverse linear function (Multiplier=C÷keyed value)
Exponential function (Multiplier=C×ln (keyed value))

As an alternative, the Multiplier may be calculated using a deterministic formula. The simplest of such formula may be as follows where C=fixed constant value and the Multiplier becomes a direct linear function of the keyed value. E.g., Multiplier=C×Keyed Value.

Or, the Multiplier may be configured as an inverse linear function of the keyed reference item. E.g., Multiplier=C÷Keyed Value

Note that the value C may be established as either a positive or negative number, noting that a negative number would facilitate an inverse variable exposure contract, as shown in Table 2 below. A rounding algorithm may subsequently be applied to ensure that the Multiplier is equal to a round number, e.g., the Multiplier is rounded to the nearest integral multiple of $5.

E.g. if C=−60,000 then the Multiplier may be calculated as −$50 if the S&P 500=1,200. Multiplier='60,000÷1,200=−$50.

TABLE 2
Example: Inverse Linear Function

| Keyed Value | Multiplier |
|---|---|
| 1,000 | −$60 |
| 1,100 | −$55 |
| 1,200 | −$50 |
| 1,300 | −$45 |
| 1,400 | −$40 |

As another alternative, the Multiplier may be calculated an exponential function of the keyed value as shown in Table 3 below. E.g., Multiplier=C×ln(Keyed Value). Or, the Multiplier may be configured as an inverse exponential function of the level of the keyed reference item as follows: Multiplier=C=ln(Keyed Value)

Again, the value C may be established as either a positive or negative number, noting that a negative number would facilitate an inverse variable exposure contract. Again, a rounding algorithm may be applied to ensure that the Multiplier is equal to a round number, e.g., the Multiplier is rounded to the nearest integral multiple of $2.

E.g. if C=−350 then the Multiplier may be calculated as −$50 if the S&P 500=1,200. Multiplier=−350÷ln(1,200)=−$50

TABLE 3
Example: Inverse Exponential Function

| Keyed Value | Multiplier | Rounded Multiplier |
|---|---|---|
| 800 | −$52.36 | −$52 |
| 1,000 | −$50.67 | −$50 |
| 1,200 | −$49.36 | −$50 |
| 1,400 | −$48.31 | −$48 |
| 1,600 | −$47.44 | −$48 |

Equity asset managers frequently wish to hedge their stock market holdings against the risk of bear markets. As discussed above, this is readily accomplished by the sale of conventional stock index futures. Inverse futures, as described above, might be utilized where artificial constraints, by charter, policy or regulation, hinder an asset manager's ability to sell or go short conventional stock index futures.

Beyond a hedge using futures contracts, however, many equity asset managers would like to hedge their risks through the purchase of long-term put options. The net result of such a hedge is to create a portfolio where risk exposure, in the event of a major market decline, is limited but where the ability to participate in potential upside market movements remains unlimited except to the extent that an option premium is paid.

Unfortunately, the cost of purchasing such long-term put options has generally proven to be prohibitive. Accordingly, equity asset managers have sought alternative ways to construct risk/reward profiles that replicate a long equity portfolio hedged with the purchase of put options.

One way to replicate the performance of a long-term put hedge was created in the 1980's with the introduction of so-called “portfolio insurance” programs. Portfolio insurance programs contemplate that asset managers hold short futures against a long equity portfolio. But rather than holding a static number of short futures contracts, the short futures position would be managed in such a way as to replicate the performance of long put options. Long options, including put options, exhibit a property known as “convexity.”

This means that as the market declines, the long put option will become increasingly responsive or sensitive to further market declines, i.e., the price or premium of these options will advance more sharply as the market declines. As the market advances, the long put option will become increasingly unresponsive or insensitive to further market advances, i.e., the option premium will decline increasingly slower as the market advances.

The purveyors of portfolio insurance programs observed that one might replicate the convexity property of long put options with a managed portfolio of short futures positions. Specifically, one might sell futures in proportions dictated by the delta of the long put position one wishes to replicate.

As the market declines, one might sell more futures so that the net short futures position becomes larger, in proportion to the delta of the long put position one wishes to replicate. As the market advances, one might buy back futures so that the net short futures position becomes smaller, in proportion to the delta of the long put position one wishes to replicate. Delta represents the expected change in the price of an option relative to a change in the value of the underlying instrument. Note that a long put option is essentially a bearish position as it represents the right to sell the underlying instrument at a fixed strike or exercise price regardless of how low the underlying market may decline. Thus, the premium associated with a long put will advance as the underlying market declines; and will decline as the underlying market advances. The degree to which put option prices or premiums will respond to changes in the underlying market price may be measured by delta. Option deltas will vary between 0 and 1.0 as delta is essentially driven by the “money-ness” of the option. An “at-the-money” option, where the underlying market price equals the option strike or exercise price, will tend to have a delta near 0.5. Its premium will be roughly half as sensitive as the underlying market price. An option that is deep “in-the-money,” i.e., a put whose strike price is well above the current market price, will tend to have a delta near 1.0. Its premium will be move in direct proportion to movements in the underlying market price. An option that is deep “out-of-the-money,” i.e., a put whose strike price is well below the current market price, will tend to have a delta near 0.0. Thus, it will be insensitive to changes in the underlying market price. Delta is generally calculated as the first derivative of the option premium relative to the underlying market price as applied to mathematical option pricing formulae, e.g., the Black-Scholes option pricing model.

Portfolio insurance programs are, therefore, quite intuitive. They require that you sell more futures in a bear market and liquidate portions of the short futures position in a bull market.

Unfortunately, it is not always easy to determine whether the market will decline or advance in the future. Thus, these programs are subject to the risk of “whipsaw” markets. E.g., the market declines and you sell additional futures. Subsequently, the market advances and you buy-back or cover those additional short futures at a higher market price.

These programs came under some further criticism in the wake of the October 1987 stock market crash. Note that portfolio insurance programs may be implemented with the use of “stop sell orders” that require one to sell when the market declines to a predetermined level. Often, these stop sell orders are placed at many different levels below the current market price.

Still, the concept of replicating a long put hedge without the attendant payment of an expensive option premium holds much appeal to equity asset managers as a means to achieve a much desired risk/reward profile.

Construction and use of inverse variable exposure (VE) contracts, whereby the variable multiplier value is negative, can be used to create a “synthetic” portfolio insurance program. To the extent that the effective multiplier of the contract becomes increasingly negative, through some deterministic function, these contracts, once placed, represent an automated, self-adjusting mechanism to accomplish the same goals as a conventionally constructed portfolio insurance program. As such, this approach does not necessarily require active management.

To replicate portfolio insurance-like properties, the effective multiplier may also take on a time dimension, i.e. the value of the multiplier is also a function of a temporal parameter, such as the time remaining to the expiry date of the futures contract.

Other examples of multiplier formulas include (where C=a constant; T=time dependent parameter):
Linear function (Multiplier=C×keyed value×T)
Inverse linear function (Multiplier=C÷keyed value×T)
Exponential function (Multiplier=C×ln (keyed value×T))

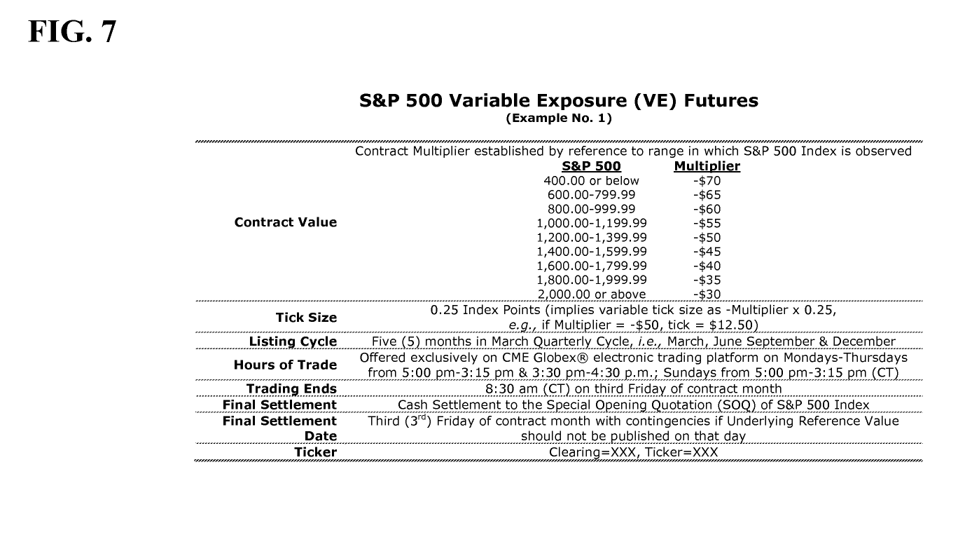

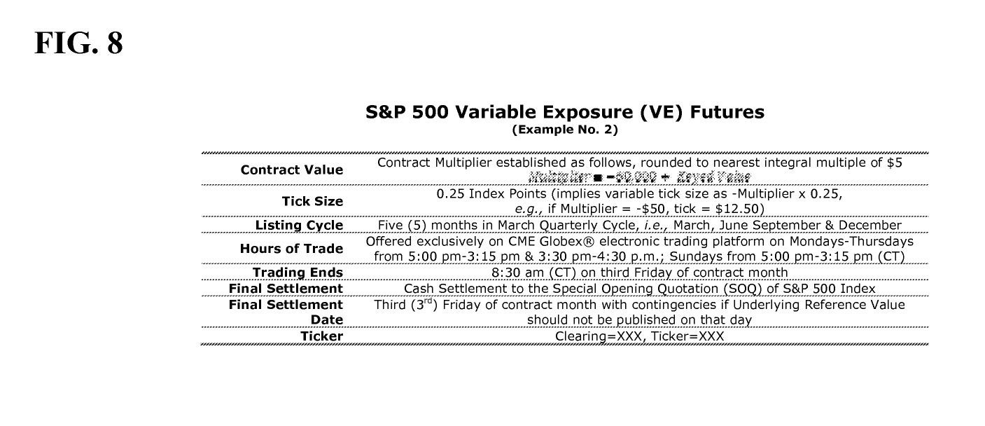

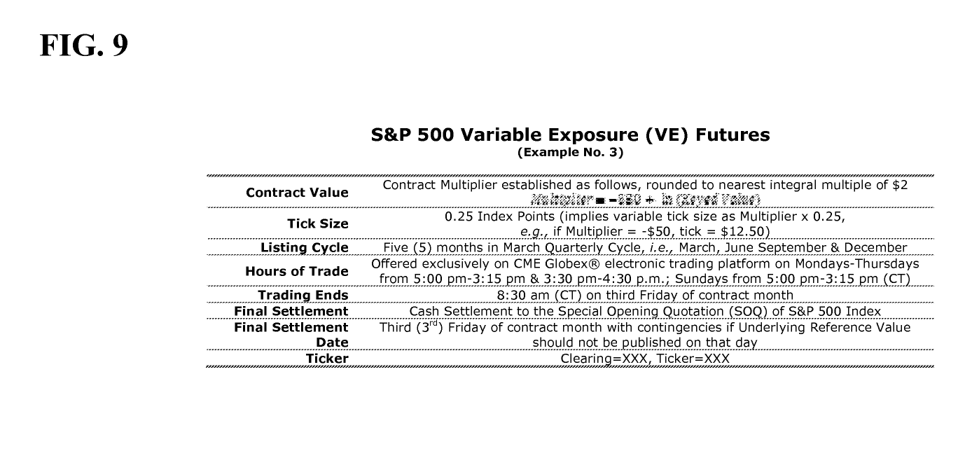

FIGS. 7-9 depict tables showing parameters of exemplary S&P 500 Variable futures contracts constructed in accordance with the disclosed embodiments, having an incremental multiplier (FIG. 7), an inverse linear multiplier (FIG. 8), and an exponential multiplier (FIG. 9).

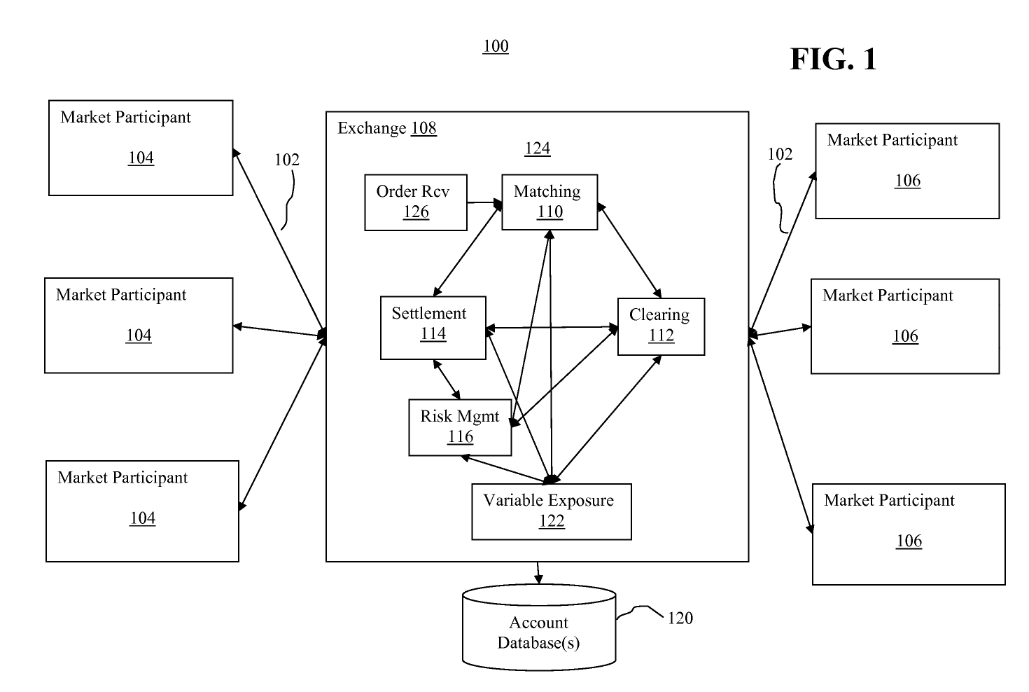

Referring now to FIG. 1, there is shown a block diagram of an exemplary network 100 for trading futures contracts, including in which payer contracts may be implemented, according to the disclosed embodiments. The network 100 couples market participants 104, 106, such as traders 104 and market makers 106, with an exchange 108, such as the CME, also referred to as a central counterparty or intermediary, via a communications network 102, such as the Internet, an intranet or other public or private, secured or unsecured communications network or combinations thereof. The network 100 may also be part of, or alternatively coupled with a larger trading network, allowing market participants 104 106 to trade products, such as futures contracts, options contracts, foreign exchange instruments, etc., via the exchange 108, including logged derivatives contracts as described herein. It will be appreciated that the plurality of entities utilizing the disclosed embodiments, e.g. the market participants 104, 106, may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant 104 106 and/or the exchange 108.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The exchange 108 implements the functions of matching 110 buy/sell transactions, clearing 112 those transactions, settling 114 those transactions and managing risk 116 among the market participants 104 106 and between the market participants and the exchange 108, as well as variable exposure contract functionality 122 for administering variable exposure contracts as will be described. The exchange 108 may include or be coupled with one or more database(s) 120 or other record keeping system which stores data related to open, i.e. un-matched, orders, matched orders which have not yet been delivered, or other data, or combinations thereof.

Typically, the exchange 108 provides a “clearing house” (not shown) which is a division of the Exchange 108 through which all trades made must be confirmed, matched and settled each day until offset or delivered. The clearing house is an adjunct to the Exchange 108 responsible for settling trading accounts, clearing trades, collecting and maintaining performance bond funds, regulating delivery and reporting trading data. The clearing house essentially mitigates credit risk. Clearing is the procedure through which the Clearing House becomes buyer to each seller of a futures contract, and seller to each buyer, also referred to as a “novation,” and assumes responsibility for protecting buyers and sellers from financial loss by assuring performance on each contract. This is effected through the clearing process, whereby transactions are matched. A clearing member is a firm qualified to clear trades through the Clearing House.

As used herein, the term “Exchange” 108 will refer to the centralized clearing and settlement mechanisms, risk management systems, etc., as described below, used for futures trading. In the presently disclosed embodiments, the Exchange 108 assumes an additional role as the central counterparty in variable exposure derivatives contracts, computing variable values for the purposes of quoting, pricing and settling such contracts.

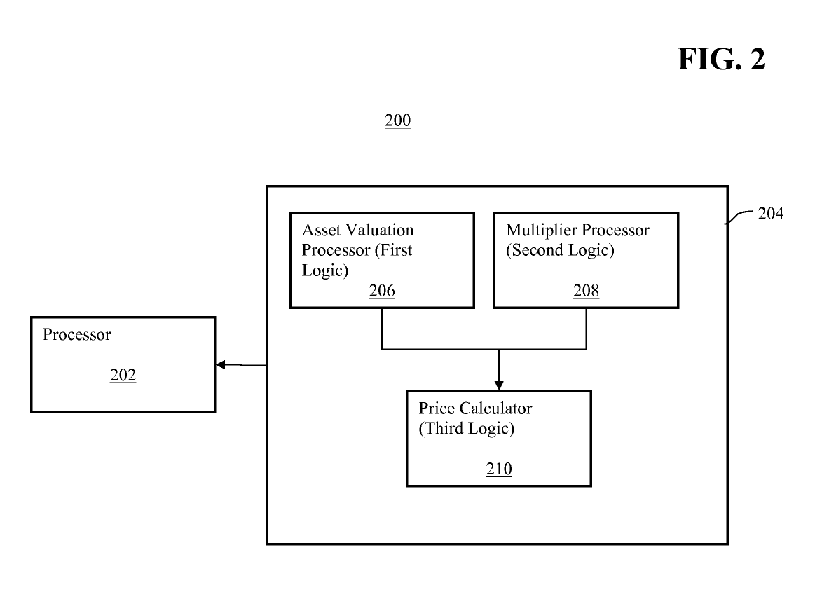

Referring to FIG. 2, a system 200 for computing a price of a futures contract for the delivery of an underlying asset, such as quote price or a settlement price, according to one embodiment is shown. The system 200 implements the variable exposure contract functionality 122 of the system 100 described above. The system 200, which may include a processor 202 and a memory 204 coupled therewith, includes an asset valuation processor 206, which may be implemented as first logic stored in the memory 204 and executable by the processor 202, coupled with the exchange 108 and/or network 102 so as to receive appropriate market information and operative to determine a value of the underlying asset; and a multiplier processor 208, which may be implemented as second logic stored in the memory 204 and executable by the processor 202 operative to compute a multiplier value based on a value of at least one variable parameter, where the multiplier value varies as a function of the value of the at least one variable parameter. The system 200 further includes a price calculator 210, which may be implemented as third logic stored in the memory 204 and executable by the processor 202, coupled with the asset valuation processor 206 and the multiplier processor 208 and operative to compute the price as the multiplier value multiplied by the value of the underlying asset. The price calculator 208 is further coupled with the exchange 108 and/or network 102 so as to provide the computed first price thereto.

The variance of the value of the at least one variable parameter, or key, may be correlated with, or independent of, the variance in the value of the underlying asset. In one embodiment, the at least one variable parameter is the value of the underlying asset. Alternatively, the at least one variable parameter comprises a value of a market index.

The multiplier value may be a negative value, a positive value or range between positive and negative values, including zero.

In one embodiment, the multiplier processor 208 is further operative to determine the multiplier value based on a temporal parameter, such as the number of days remaining until an event, such as the expiration of the contract. A temporal parameter, for example, may be used to decay the multiplier value over time.

The multiplier value may be computed such that it increases, proportionally or non-proportionally, linearly or non-linearly, exponentially, incrementally or continuously, or combinations thereof, as the value of the at least one variable parameter increases, and vice versa. Alternatively, the multiplier value may be computed such that it increases, proportionally or non-proportionally, linearly or non-linearly, exponentially, incrementally or continuously, as the value of the at least one variable parameter decreases and vice versa. It will be appreciated that the multiplier may increase in a different manner than it decreases. For example, it may increase exponentially and decrease linearly. In an alternative embodiment, the multiplier may increase and/or decrease based on the magnitude of change in the at least one variable parameter such that, for example, the multiplier increases in highly volatile markets and decreases as the volatility subsides, or vice versa.

In one embodiment, the at least one variable parameter comprises market performance, such as a market performance indicator, the multiplier value being negative and decreasing as a function of declines in market performance independent of the value of the underlying asset.

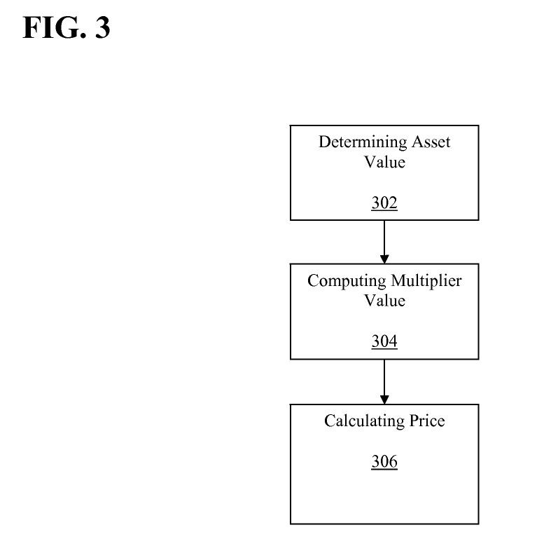

FIG. 3 depicts a flow chart showing operation of the system of FIGS. 1 and 2. In particular FIG. 3 shows a computer implemented method of computing a price of a futures contract for the delivery of an underlying asset, such as a quote price or a settlement price. The method includes: determining, by a processor, a value of the underlying asset (block 302); determining, by the processor, a multiplier value based on a value of at least one variable parameter, where the multiplier value varies as a function of the value of the at least one variable parameter (block 304); and multiplying, by the processor, the multiplier value by the value of the underlying asset, the price resulting therefrom (block 306).

The variance of the value of the at least one variable parameter, or key, may be correlated with, or independent of, the variance in the value of the underlying asset. In one embodiment, the at least one variable parameter is the value of the underlying asset. Alternatively, the at least one variable parameter comprises a value of a market index.

The multiplier value may be a negative value, a positive value or range between positive and negative values, including zero.

In one embodiment, the multiplier processor 208 is further operative to determine the multiplier value based on a temporal parameter, such as the number of days remaining until an event, such as the expiration of the contract. A temporal parameter, for example, may be used to decay the multiplier value over time.

The multiplier value may be computed such that it increases, proportionally or non-proportionally, linearly or non-linearly, exponentially, incrementally or continuously, or combinations thereof, as the value of the at least one variable parameter increases, and vice versa. Alternatively, the multiplier value may be computed such that it increases, proportionally or non-proportionally, linearly or non-linearly, exponentially, incrementally or continuously, as the value of the at least one variable parameter decreases and vice versa. It will be appreciated that the multiplier may increase in a different manner than it decreases. For example, it may increase exponentially and decrease linearly. In an alternative embodiment, the multiplier may increase and/or decrease based on the magnitude of change in the at least one variable parameter such that, for example, the multiplier increase in highly volatile markets and decreases as the volatility subsides, or vice versa. Alternatively, or in addition thereto, minimum and/or maximum multiplier values, or other constraints, may be defined to constrain the possible multiplier values.

In one embodiment, the at least one variable parameter comprises market performance, such as a market performance indicator, the multiplier value being negative and decreasing as a function of declines in market performance independent of the value of the underlying asset.

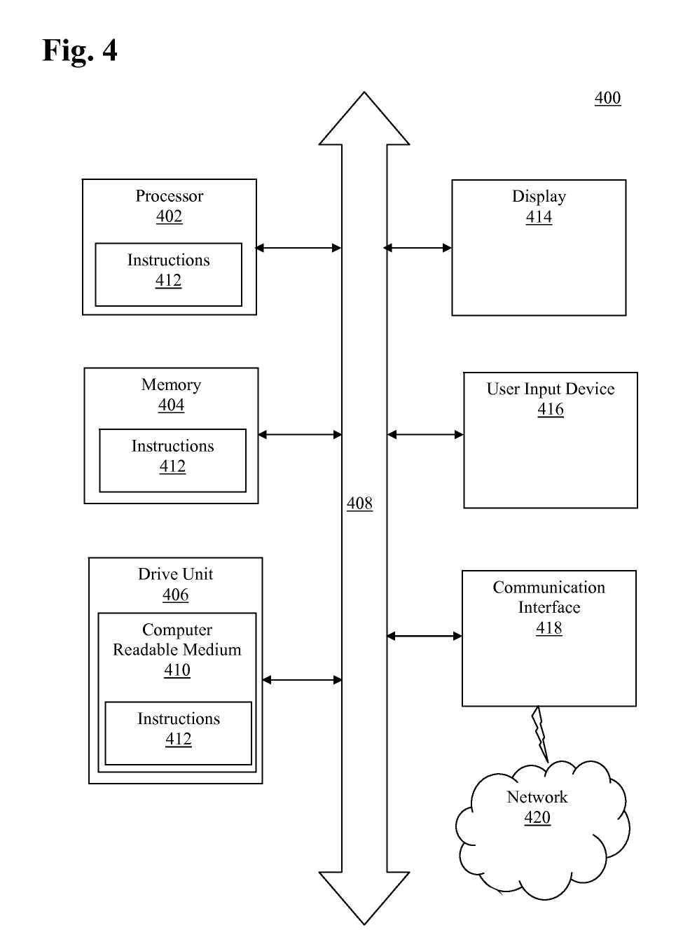

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above, such as the processor 202, may be a computer system 400 or a component in the computer system 400. The computer system 400 may implement a match engine, margin processing, payment or clearing function on behalf of an exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

We claim:

1. A computer implemented method of computing a price of a futures contract for the delivery of an underlying asset, the method comprising:
determining, by a processor, a value of the underlying asset;
determining, by the processor, a multiplier value based on a value of at least one variable parameter, where the multiplier value varies as a function of the value of the at least one variable parameter; and
multiplying, by the processor, the multiplier value by the value of the underlying asset, the price resulting therefrom.

2. The computer implemented method of claim 1 wherein the price comprises one of a quote or a settlement price.

3. The computer implemented method of claim 1 wherein the multiplier value comprises a negative value.

4. The computer implemented method of claim 1 wherein a variance of the value of the at least one variable parameter is correlated with a variance of the value of the underlying asset.

5. The computer implemented method of claim 1 wherein a variance of the value of the at least one variable parameter is independent of a variance of the value of the underlying asset.

6. The computer implemented method of claim 1 wherein the determining of the multiplier value further comprises determining the multiplier value based on a temporal parameter.

7. The computer implemented method of claim 1 wherein the at least one variable parameter is the value of the underlying asset.

8. The computer implemented method of claim 1 wherein the at least one variable parameter comprises a value of a market index.

9. The computer implemented method of claim 1 wherein the multiplier value increases as the value of the at least one variable parameter increases.

10. The computer implemented method of claim 1 wherein the multiplier value decreases as the value of the at least one variable parameter decreases.

11. The computer implemented method of claim 1 wherein the multiplier value decreases as the value of the at least one variable parameter increases.

12. The computer implemented method of claim 1 wherein the multiplier value increases as the value of the at least one variable parameter decreases.

13. The computer implemented method of claim 1 wherein the multiplier value varies linearly with respect to variance in the value of the at least one variable parameter.

14. The computer implemented method of claim 1 wherein the multiplier value varies non-linearly with respect to variance in the value of the at least one variable parameter.

15. The computer implemented method of claim 1 wherein the multiplier value varies exponentially with respect to variance in the value of the at least one variable parameter.

16. The computer implemented method of claim 1 wherein the multiplier value varies incrementally with respect to variance in the value of the at least one variable parameter.

17. The computer implemented method of claim 1 wherein the multiplier value varies continuously with respect to variance in the value of the at least one variable parameter.

18. The computer implemented method of claim 1 wherein the at least one variable parameter comprises market performance, the multiplier value being negative and decreasing as a function of declines in market performance independent of the value of the underlying asset.

19. A system for computing a price of a futures contract for the delivery of an underlying asset, the system comprising:
an asset valuation processor operative to determine a value of the underlying asset;
a multiplier processor operative to compute a multiplier value based on a value of at least one variable parameter, where the multiplier value varies as a function of the value of the at least one variable parameter; and
a price calculator coupled with the asset valuation processor and the multiplier processor and operative to compute the price as the multiplier value multiplied by the value of the underlying asset.

20. The system of claim 19 wherein the price comprises one of a quote or a settlement price.

21. The system of claim 19 wherein the multiplier value comprises a negative value.

22. The system of claim 19 wherein a variance of the value of the at least one variable parameter is correlated with a variance of the value of the underlying asset.

23. The system of claim 19 wherein a variance of the value of the at least one variable parameter is independent of a variance of the value of the underlying asset.

24. The system of claim 19 wherein the multiplier processor is further operative to determine the multiplier value based on a temporal parameter.

25. The system of claim 19 wherein the at least one variable parameter is the value of the underlying asset.

26. The system of claim 19 wherein the at least one variable parameter comprises a value of a market index.

27. The system of claim 19 wherein the multiplier value increases as the value of the at least one variable parameter increases.

28. The system of claim 19 wherein the multiplier value decreases as the value of the at least one variable parameter decreases.

29. The system of claim 19 wherein the multiplier value decreases as the value of the at least one variable parameter increases.

30. The system of claim 19 wherein the multiplier value increases as the value of the at least one variable parameter decreases.

31. The system of claim 19 wherein the multiplier value varies linearly with respect to variance in the value of the at least one variable parameter.

32. The system of claim 19 wherein the multiplier value varies non-linearly with respect to variance in the value of the at least one variable parameter.

33. The system of claim 19 wherein the multiplier value varies exponentially with respect to variance in the value of the at least one variable parameter.

34. The system of claim 19 wherein the multiplier value varies incrementally with respect to variance in the value of the at least one variable parameter.

35. The system of claim 19 wherein the multiplier value varies continuously with respect to variance in the value of the at least one variable parameter.

36. The system of claim 19 wherein the at least one variable parameter comprises market performance, the multiplier value being negative and decreasing as a function of declines in market performance independent of the value of the underlying asset.

37. A system for computing a price of a futures contract for the delivery of an underlying asset, the system comprising a processor and a memory coupled therewith, the system further comprising:
first logic stored in the memory and executable by the processor to determine a value of the underlying asset;
second logic stored in the memory and executable by the processor to compute a multiplier value based on a value of at least one variable parameter, where the multiplier value varies as a function of the value of the at least one variable parameter; and
third logic stored in the memory, coupled with the first and second logic, and executable by the process to compute the price as the multiplier value multiplied by the value of the underlying asset.

38. A system for computing a price of a futures contract for the delivery of an underlying asset, the system comprising:
means for determining, by a processor, a value of the underlying asset;
means for determining, by the processor, a multiplier value based on a value of at least one variable parameter, where the multiplier value varies as a function of the value of the at least one variable parameter; and
means for multiplying, by the processor, the multiplier value by the value of the underlying asset, the price resulting therefrom.
